(19) United States
(12) Patent Application Publication
(10) Pub. No.: US 2015/0367826 A1
(43) Pub. Date: Dec. 24, 2015

(54) BRAKE UNIT FOR A VEHICLE AND VEHICLE WITH A BRAKE UNIT OF THIS TYPE

(71) Applicant: SIEMENS AKTIENGESELLSCHAFT, München (DE)

(72) Inventors: MARKUS BILDSTEIN, OBERSTAUFEN (DE); ANTON GAILE, LEUTKIRCH (DE); TONI SCHIFFERS, ERKELENZ (DE)

(21) Appl. No.: 14/765,069

(22) PCT Filed: Jan. 8, 2014
(86) PCT No.: PCT/EP2014/050229

§ 371 Date: Jul. 31, 2015

(30) Foreign Application Priority Data
Jan. 31, 2013 (DE) 10 2013 201 623.9

(51) Int. Cl. B60T 13/66; B61H 15/00; B61H 5/00; B60T 13/68

(52) U.S. Cl. CPC B60T 13/665; B60T 13/686; B61H 15/0028; B61H 5/00

(57) ABSTRACT

A brake unit for a vehicle, in particular a rail vehicle, includes an electrohydraulic setpoint value-force-conversion device having a container for providing hydraulic fluid, a brake cylinder connected to the container via a hydraulic line system and having brake pistons, and control devices suitably constructed so as, under the action of electric output signals of a setpoint-value-regulating device, to adjust an actual value, which acts upon the brake cylinder, of a hydraulic pressure in the brake cylinder. In a structurally advantageous manner, one of the control devices is a pump unit with which hydraulic fluid can be pumped out of the container into the brake cylinder and another of the control devices is suitably constructed to allow hydraulic fluid to flow out of the brake cylinder into the container. A vehicle with such a brake unit is also provided.

The invention relates to a brake unit for a vehicle, in particular a rail vehicle, with an electrohydraulic setpoint value-force-conversion device, which comprises a container for providing hydraulic fluid, a brake cylinder with brake pistons connected to the container via a hydraulic line system as well as control means, wherein the control means are of suitable design so as, under the action of electrical output signals of a setpoint-value-regulating device, to set an actual value of a hydraulic pressure in the brake cylinder which acts upon the brake piston.

A brake unit of this type, which has its own hydraulic supply and hence does not require a hydraulic interface with the vehicle, is known, for example, from the publication WO 2008/031701. This known brake unit has self-energizing hydraulics so that the first friction means have to move in a structurally complex way relatively to the second friction means in a deceleration force direction.

On this basis, the invention is based on the object of simplifying the structure of the brake unit.

This object is achieved with a brake unit with the features of claim 1 in that one of the control means is a pump assembly by means of which hydraulic fluid can be pumped out of the container into the brake cylinder and that a further one of the control means is of suitable design to allow hydraulic fluid to flow out of the brake cylinder into the container.

This enables the brake unit according to the invention to manage without structurally complex self-energization and but nevertheless still does not have any external hydraulic interface with the vehicle.

The brake unit preferably has first braking means which are of suitable design to convert an actual value of a contact force resulting from the action of the brake piston into an actual value of a deceleration parameter by friction locking with second braking means.

It is considered to be advantageous to have a connecting part for mounting the brake unit, in particular on a running gear of a rail vehicle, by means of which the setpoint value-force-conversion device and the first braking means are connected to a modular unit. This is because this modular unit can be pre-assembled in a simple way and can be designed compatible with brake units used to date with respect to installation space and mechanical interfaces with the vehicle but without requiring an external hydraulic supply from the vehicle or a hydraulic interface with the vehicle.

It is also considered to be advantageous for the setpoint-value-regulating device and a sensor device to be components the brake unit, wherein the sensor device determines the actual value of the hydraulic pressure or the actual value of the contact force as the actual value of a contact parameter and/or the actual value of the deceleration parameter and wherein the setpoint-value-regulating device is of suitable design, for the regulation of the deceleration parameter, to output the output signals such that the actual value of the deceleration parameter determined at least corresponds to a setpoint value of the deceleration parameter, or for the regulation of the contact parameter, to input the output signals such that the actual value of the contact parameter determined at least corresponds to a setpoint value of the contact parameter.

Hence, suitable parameterization of the setpoint-value-regulating device enables the brake unit to be adapted in a simple way for project-specific requirements so that a maximum degree of standardization can be achieved with this brake unit.

Also considered to be advantageous are means for presetting an air gap between the first braking means and the second braking means to a prespecified air gap value. Preferably, these means are of suitable design, in the case of wear on the braking, automatically to reset the air gap to the prespecified air gap value. To this end, these means advantageously have a non-self-locking threaded spindle which is screwed concentrically into the brake piston, a ratchet wheel connected to the threaded spindle by means of face toothing or friction locking supported by means of an axial rolling bearing on the brake cylinder and two end stops that restrict the angle of rotation of the ratchet wheel to a prespecified value of the angle of rotation. In this context, it is considered to be advantageous for the value of the angle of rotation to be adjustable by moving the end stops.

In a further preferred embodiment of the brake unit according to the invention, locking means are provided which are of suitable design to lock the brake piston mechanically in the case of park braking. Preferably, these locking means comprise a locking latch, which is of suitable design to engage in a detent groove of the ratchet wheel. In this context, the locking latch can be actuated hydraulically and/or mechanically.

The invention relates to a vehicle, in particular a rail vehicle, with a running gear on which a brake unit according to the invention is mounted for friction locking with braking means of a wheel set of the running gear.

For further explanation of the invention,

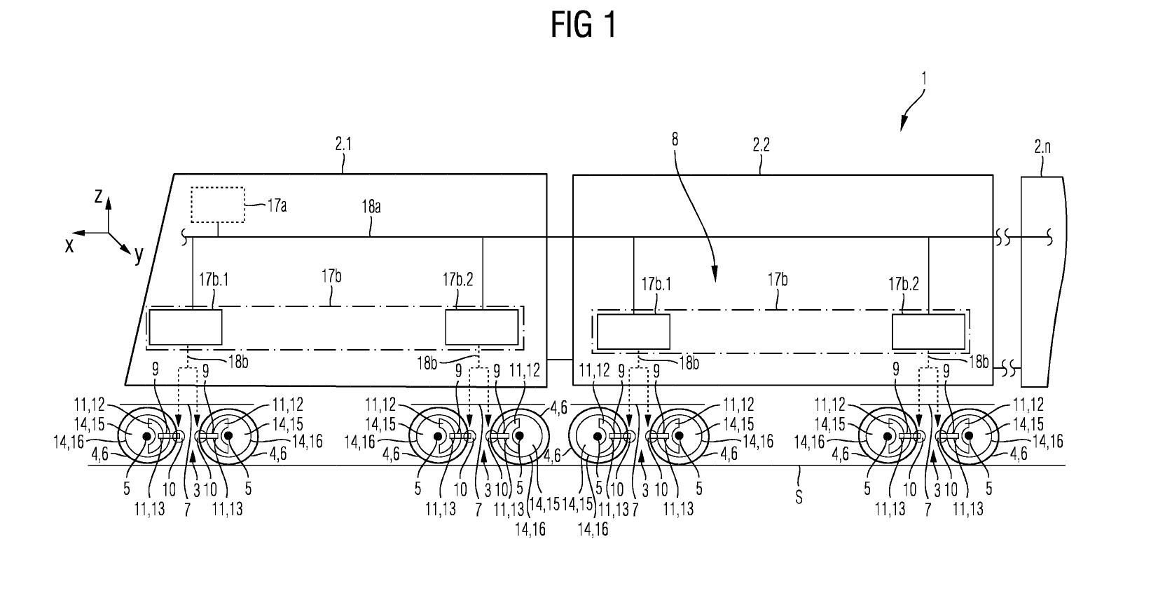

FIG. 1 shows a vehicle according to the invention in the form of a rail vehicle with which in each case at least one brake unit is assigned to wheel sets of bogies,

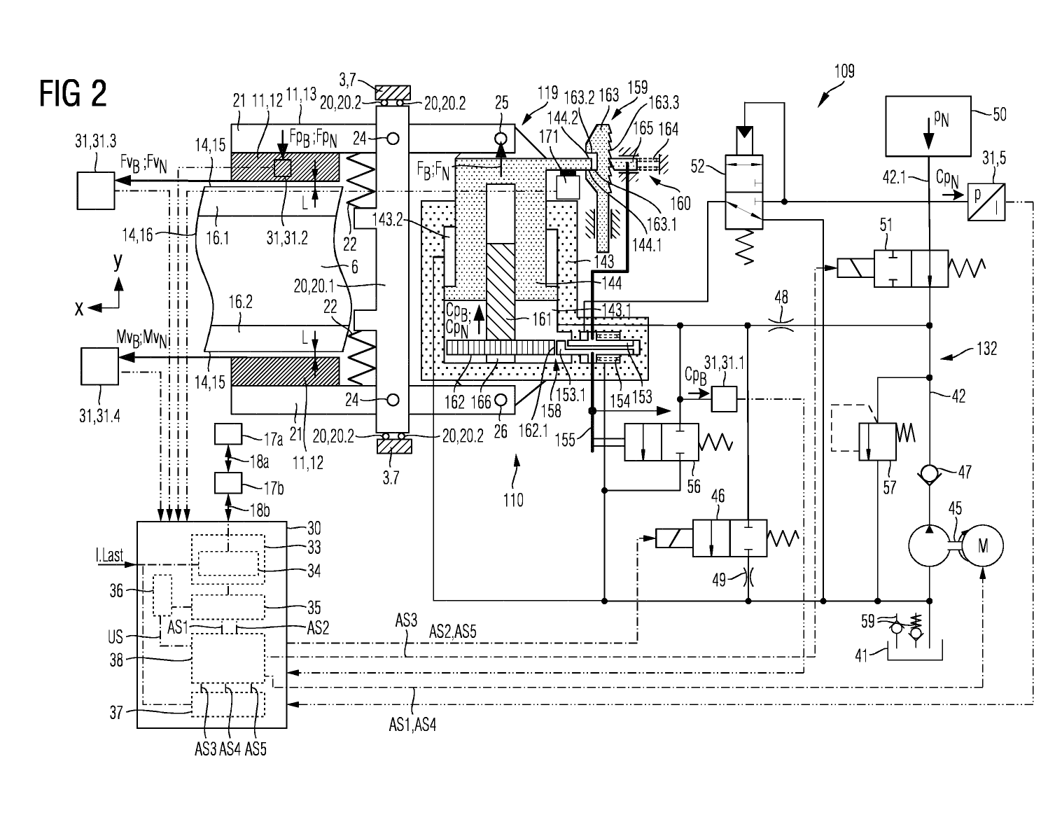

FIG. 2 shows a first embodiment of the brake unit according to the invention,

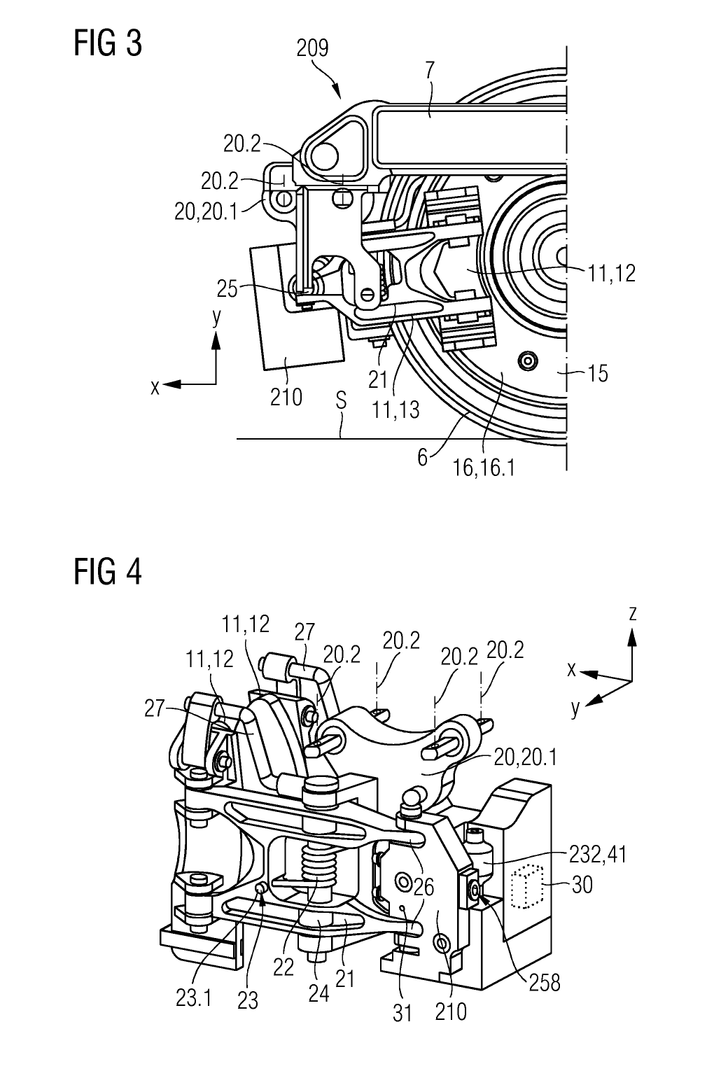

FIGS. 3 and 4 show a second embodiment of the brake unit according to the invention,

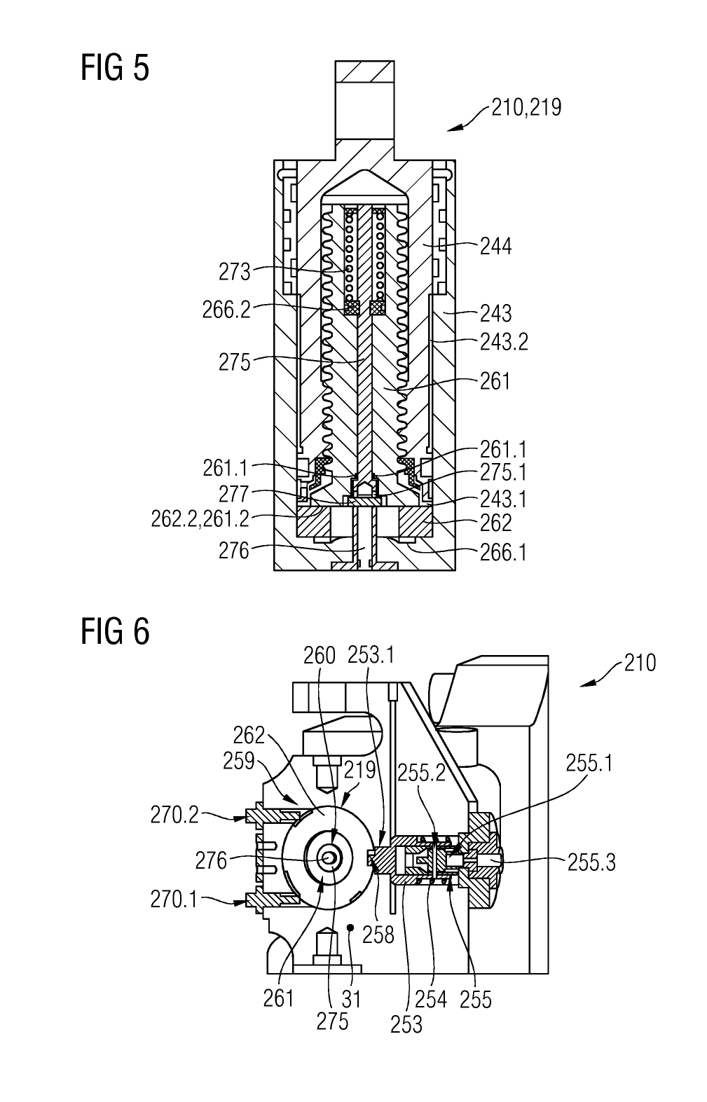

FIGS. 5 and 6 show a brake-piston device of the brake unit shown in FIGS. 3 and 4 in different sectional views and

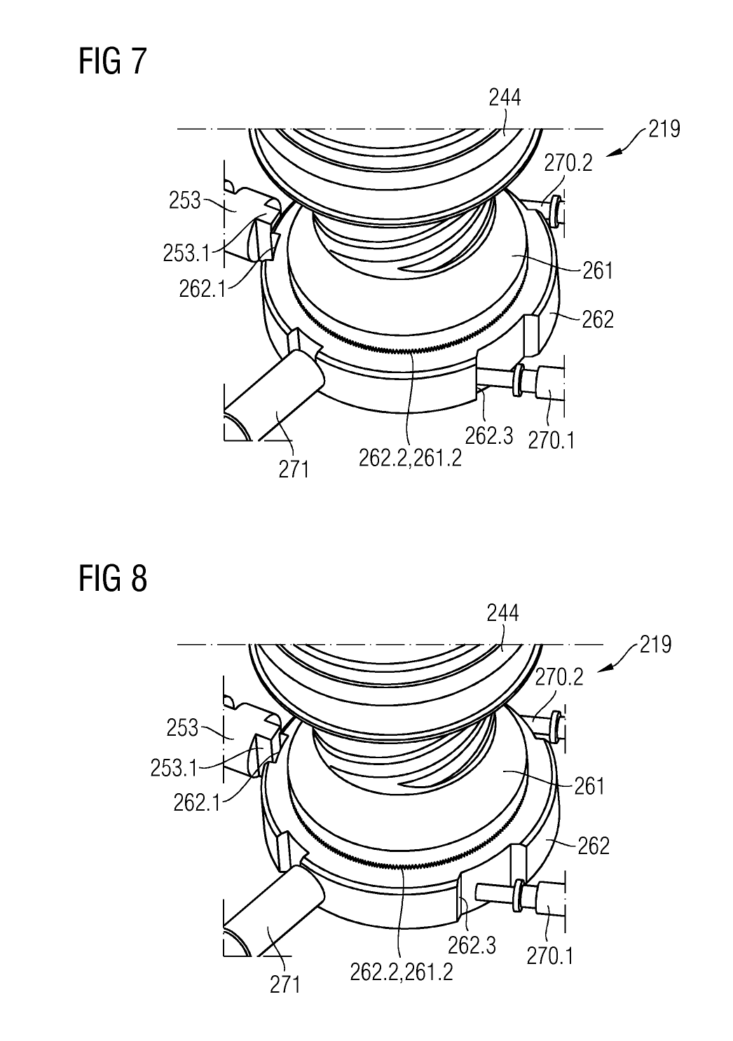

FIGS. 7 to 12 show parts of the brake-piston device shown in FIGS. 5 and 6 in different positions of its motional sequence.

According to FIG. 1, the rail vehicle 1 has freight cars 2.1, 2.2, . . . 2.n, the freight car boxes of which are each supported in a manner not shown here by a secondary suspension of two moving devices in the form of bogies 3. The bogies 3 each have two wheel sets 4. The wheel sets 4 each have a shaft 5 on the end of which wheels 6 are held. In this context, the shafts 5 of the wheel sets 4 are rotatably mounted in a way not shown here in wheel set bearings connected via a housing and a primary suspension to a bogie frame 7 of the respective bogie 3. The rail vehicle 1 also has a braking system here designated as a whole with 8.

Usually in each case at least one brake unit according to the invention 9 is assigned to each shaft 5 of the rail vehicle 1. Hence, each of the freight cars 2.1, 2.2, . . . 2.n has at least four of these brake units 9.

Each of the brake units 9 has a brake actuator 10 and first braking means 11 actuated by the brake actuator 10 in the form of an application device 13 provided with brake linings 12. In this context, the first braking means 11 of each of these brake units 9 interact in each case with second braking means 14 in the form of a brake disk 16 provided with brake friction surfaces 15. Here, the brake friction surfaces 15 are formed from two partial brake disks 16.1, 16.2 mounted on both sides of a wheel 6 assigned to the brake unit 9 so that the wheel 6 provided with the two partial brake disks 16.1, 16.2 forms the brake disk 16 in the form of a wheel brake disk (see FIGS. 2 and 3).

However, it is also possible, instead of a wheel brake disk, for a shaft brake disk to be provided with which then a separate disk with brake friction surfaces would be provided arranged in a rotatably fixed manner on the shaft 5. The first braking means could also interact with a second braking means in the form of the wheel or in the form of a brake drum.

The application device 13 provided with the brake linings 12 can be applied under the action of the brake actuator 10 for the build-up of a frictional connection between the first braking means 11 and the second braking means 14 via the brake disk 16.

The brake actuator 10 is an electrohydraulic brake actuator.

The braking system 8 has a central control device 17a and in each of the freight cars 2.1, 2.2, . . . 2.n a brake controller 17b formed by one or two brake control devices 17b.1 and 17b.2. In this context, the brake control devices 17b.1 and 17b.2 can be controlled via a train bus 18a by the central control device 17a of the braking system 8 formed, for example by a central vehicle control.

The brake actuators 10 of the brake units 9 or groups of the brake actuators each receive a brake command via the brake controller 17b. In this context, the brake commands can be transmitted via one or more control wires 18b and/or BUS and/or via radio to the brake actuators 10.

FIG. 2 is a schematic diagram of a first embodiment 109 of the brake unit according to the invention with a first embodiment 110 of the brake actuator.

FIGS. 3 and 4 show a second embodiment 209 of the brake unit according to the invention with a second embodiment 210 of the brake actuator and FIGS. 5 to 12 shows details of this second embodiment 210 of the brake actuator.

However, the two embodiments 109 and 209 of the brake unit substantially only differ in the structural design of a brake-piston device of their brake actuators 110 or 210 designated as a whole with 119 or 219 so that the components of the two embodiments 109 and 209 of the brake unit, which are substantially embodied identically, are in each case designated with the same reference numbers in FIG. 2 or 3 to 12.

To mount (suspend) them on the bogie frame 7, the two embodiments 109 and 209 of the brake unit 9 have a connecting part designated as a whole with 20 on which the application device 13 is held. The connecting part 20 comprises a brake bridge 20.1 and is fixed on the bogie frame 7 by screw connections 20.2. However, the brake units 109; 209 can also be mounted elsewhere on the running gear, for example on a transmission housing or a wheel set flange of the bogie.

The application device 13 is embodied by means of two brake levers 21 as a brake caliper. However, the application device could alternatively also be embodied as a brake saddle.

During the first assembly of the brake unit 109; 209 on the bogie frame 7, the position of the brake unit 109; 209 on the bogie frame 7 can be adjusted by means of the screw connections 20.2; however subsequent adjustment is very cumbersome.

Nevertheless, during operational use, following the first assembly of the brake unit 109; 209, non-uniform wear of the brake linings 12 and the brake friction surfaces 15 of the brake disk 16 due to relative motion of the bogie 3 or even due to sluggishness of the application device 13 can have the result that only one of the brake linings 12 lies on the brake friction surface 15 of the brake disk 16 assigned thereto or that the size of an air gap L between the two brake linings 12 and the brake friction surfaces 15 differs. Hence, in operational use, the braking means 11, 14 may be applied unilaterally.

Therefore, in each case a spring element 22 is assigned to each of the two brake levers 21. In each case, the spring elements 22 are each supported with a first end on the assigned brake lever 21 and with a second end on the brake bridge 20.1 of the connecting part 20.

The tension force of each of the two spring elements 22 can be adjusted. However, this is only shown in the second embodiment 209 of the brake unit. According to FIGS. 3 and 4, here the tension force of each of the spring elements 22 is adjusted in each case by means of an adjusting device designated as a whole with 23.

The adjusting devices 23 each comprise an adjusting screw 23.1 (also known as a “setting screw” or “stop screw”), a threaded hole of the assigned brake lever 20 for engaging the adjusting screw 23.1 and a guide slot embodied in the respective brake lever to guide the end of the spring element supported on the brake lever, which is embodied as a lever-like limb.

The adjustment of the tension forces of the spring elements 22 offers the possibility of reacting quickly and simply to unilateral application of the braking means 11, 14 in operational use. For example, relative displacement of the mounting of the brake unit 109; 209 in the transverse direction y relative to the brake friction surfaces 15 of the brake disk 16 can be compensated and the brake unit 109; 209 centered relative to the brake disk 16.

To form the brake caliper, the two brake levers 21 are each connected in an articulated manner to the connecting part 20 by means of connecting pins 24.

First lever arms of the brake levers 21 are connected in an articulated manner to receivers 25, 26 in the brake actuator 110; 210. A stroke movement of the receiver 25 drives the receivers 25, 26 apart and causes the first lever arms to be spread apart. The brake linings 12, which are applied on the spreading apart of the first lever arms via the brake disk 16, are arranged on second lever arms of the brake levers 21.

In addition to the function of establishing the air gap L of the brake linings 12 equally on both sides of the brake disk 16 (centering function), the spring elements 22 also have a reset function. The reset function consists in opening the brake caliper when the brake actuator 110; 210 does not initiate any actuation force for applying the application device 13 in the application device.

The second embodiment 209 of the braking unit according to the invention is also equipped with a device designated as whole with 27 for the parallel guidance of the brake linings, the details of which are not, however, further described here.

The two embodiments 110 and 210 of the brake actuator each comprise local electronics 30, a sensor device 31 and an electrohydraulic setpoint value-force-conversion device 132; 232, wherein the brake actuator 110; 210 with its components 30, 31 and 132; 232 and the first braking means 11 are connected to a modular unit by means of the connecting part 20.

Essential details of the local electronics 30, the sensor device 31 and the electrohydraulic setpoint value-force-conversion device 132; 232 are described below in more detail with reference to the first embodiment 110 of the brake actuator shown in FIG. 2. Where corresponding parts of the second embodiment of the 210 of the brake actuator are shown in FIGS. 3 to 6, these are designated accordingly.

The local electronics 30 form a setpoint value acquisition unit 33 provided with a setpoint value correction device 34. The local electronics also form a setpoint-value-regulating device 35, a monitoring device 36, a fallback device 37 and a switch-over device 38.

The setpoint value acquisition unit 33 requests a braking setpoint value as a function of the brake command from at least one of the brake control devices 17a.1 or 17b.2 of the brake controller 17b. The setpoint value correction device 34 performs an antiskid correction as a function of the reduction signal from an antiskid device not shown here and a load correction of the braking setpoint value as a function of an actual load value I.Last, wherein the braking setpoint value corrected in this manner is transmitted as a setpoint value S.Cp_{B}; S.Fp_{B} of a contact value Cp_{B}; Fp_{B} or as a setpoint value S.Fv_{B}; S.Mv_{B} of a deceleration parameter Fv_{B}; Mv_{B} to the setpoint-value-regulating device 35.

To determine the actual load value I.Last, the loading condition of the freight cars 2.1, 2.2, . . . , 2.n of the rail vehicle 1 is acquired at at least one position in the vehicle and notified reliably to an assigned one of the brake units 109; 209 or a group of the brake units, for example a group of the brake units in one of the bogies.

The electrohydraulic setpoint value-force-conversion device 132; 232 comprises a container 41 for providing hydraulic fluid, a brake cylinder 143; 243 with brake pistons 144; 244 connected to the container 41 via a hydraulic line system 42 and control means 45, 46. The control means 45, 46 are of suitable design, under the action of electrical output signals AS1, AS2 from the setpoint-value-regulating device 35, which are output via the switch-over device 38, to set an actual value I.Cp_{B} of a hydraulic pressure Cp_{B} in the brake cylinder 143; 243 applied to the brake piston 144; 244.

An actual value I.Fp_{B} of a contact force Fp_{B} resulting from the application of hydraulic pressure Cp_{B} to the brake piston 144; 244 is converted by friction locking of the first braking means 11 with the second braking means 14 into an actual value I.Fv_{B} of a deceleration force Fv_{B} or an actual value I.Mv_{B} of a deceleration torque Mv_{B}.

One of the control means is a pump assembly 45, by means of which hydraulic fluid can be pumped out of the container 41 into the brake cylinder 43. Another one of the control means is a brake valve 46. The brake valve 46 is of suitable design to allow hydraulic fluid to flow out of the brake cylinder 43 into the container 41.

The sensor device 31, which is a component of the brake unit 109 or 209, uses a first sensor 3.1 (pressure sensor) to determine the actual value I.Cp_{B} of the hydraulic pressure or a second sensor 31.2 to determine the actual value I.Fp_{B} of the contact pressure as the actual value of the contact parameter and/or a third sensor 31.3 to determine the actual value I.Fv_{B} of the deceleration force or a fourth sensor 31.4 to determine the actual value I.Mv_{B} of the deceleration torque as the actual value of the deceleration parameter.

The setpoint-value-regulating device 35, which is also a component of the electronics 30 of the brake unit 109 or 209, is of suitable design to output the output signals AS1, AS2 to regulate the deceleration parameter Fv_{B}; Mv_{B} such that the actual value acquired I.Fv_{B}; I.Mv_{B} of the deceleration parameter Fv_{B}; Mv_{B} corresponds to the setpoint value S.Fv_{B}; S.Mv_{B} of the deceleration parameter Fv_{B}; Mv_{B} or to input output signals AS1, AS2 to regulate the contact parameter Cp_{B}; Fp_{B} such that actual value acquired I.Cp_{B}; I.Fp_{B} of the contact parameter Cp_{B}; Fp_{B} corresponds to the setpoint value S.Cp_{B}; S.Fp_{B} of the contact parameter Cp_{B}; Fp_{B}.

The following describes the build-up and suppression of a regulated braking force F_{B} and the provision of a passive load-corrected emergency braking force F_{N} of the brake piston 144; 244 in more detail.

The brake disk 16 is braked by pressing the brake linings 12 on the brake friction surfaces 15. The pressure is applied under the action of the regulated braking force F_{B} or under the action of the passive load-corrected emergency braking force F_{N} of the brake piston 144; 244, which is absorbed in the brake cylinder 143; 243 and under the action of the regulated hydraulic pressure Cp_{B} established in the brake cylinder 143; 243 or under the action of a passive load-corrected hydraulic pressure Cp_{N} applied to the brake cylinder. The regulated braking force F_{B} or the emergency braking force F_{N} of the brake piston 44 is converted via the application device 13 into the regulated contact force Fp_{B} or into the passive contact force Fp_{N}, that is guided via the application device 13 as a contact force Fp_{B} or Fp_{N} to the brake linings 12.

In this context, the build-up of the regulated braking force F_{B} takes place via the regulated build-up of the hydraulic pressure Cp_{B} in a pullout chamber 143.1; 243.1 of the brake cylinder 43 by the pump assembly 45. To this end, the pump assembly 45 pumps hydraulic fluid in the form of hydraulic oil from the container 41 via a non-return valve 47 into the pullout chamber 143.1; 243.1 of the brake cylinder 143; 243. The non-return valve 47 prevents the hydraulic oil from flowing back into the container 41 when the pump assembly 45 is switched off.

The regulated suppression of the braking force F_{B} takes place via a regulated suppression of the hydraulic pressure Cp_{B} in the pullout chamber 143.1; 243.1 of the brake cylinder by the brake valve 46. The brake valve 46 is preferably a discretely switched seat value with very low leakage.

Hydraulic throttles 48 and 49 restrict the speed of the build-up of the hydraulic pressure in the pullout chamber 143.1; 243.1 of the brake cylinder 143; 243 and of the suppression of the hydraulic pressure in the pullout chamber 143.1; 243.1 of the brake cylinder 143; 243.

Since the weight, and hence the mass to be braked, of the rail vehicle 1 can vary in relation to the loading condition, setting the emergency braking force F_{N} too high can result in overbraking or setting the emergency braking force F_{N} too low can result in underbraking of the rail vehicle 1. Overbraking can result in skidding and flat spots on the wheel 6 and track S. Underbraking could result in inadmissibly high braking distances.

To avoid this, the brake unit according to the invention 9; 109; 209 is provided with means for providing the emergency braking force F_{N} as a load-corrected emergency braking force. In this context, this emergency braking force is set—i.e. this emergency braking force is adjusted to the current weight of the vehicle—within the permissible boundaries (empty/loaded), if:

a) the vehicle is stationary and/or

b) a door release is cancelled and/or the doors are closed and/or

c) a brake release command is present and/or

d) a drive command is present and/or

e) the speed of the vehicle is less than 10 km/h.

The provision of the load-corrected emergency braking force F_{N} takes place in that the passive load-corrected hydraulic pressure Cp_{N} is applied to the pullout chamber 143.1; 243.1 of the brake cylinder. To this end, the setpoint value-force-conversion device 132; 232 has a pressure signal transmitter 50 connected under a preload pressure p_{N} to a connection section 42.1 of the hydraulic line system 42 and further control means 51, wherein the further control means 51 are of suitable design, under the action of an electrical output signal AS3 from the fallback device 37, which is output on the input of a conversion signal US from the monitoring device via the switch-over device 38, to release the pressure signal transmitter 50 such that the actual value I-P_{N} of the preload pressure p_{N} is applied for application to the brake piston as the actual value I.Cp_{N} of the hydraulic pressure Cp_{N} to the pullout chamber of the brake cylinder.

The pressure signal transmitter 50 is a gas pressure accumulator or alternatively a spring accumulator.

The fallback device 37 performs, as a function of the actual load value I.Last, a load correction of a prespecified emergency braking setpoint value, wherein the emergency braking setpoint value load-corrected in this way is provided as a load-corrected setpoint value S.p_{N} of the preload pressure of the pressure signal transmitter 50.

The setpoint value-force-conversion device 132; 232 comprises load correction means, by means of which, to establish the passive load-corrected preload pressure p_{N} of the pressure signal transmitter 50 the hydraulic pressure Cp_{N} in the connection section 42.1 of the hydraulic line system can be set as a function of electrical output signals AS4, AS5 from fallback device to the load-corrected value S.Cp_{N}=S.p_{N}.

Here, the control means 45, 46 simultaneously form the load correction means and are of suitable design, for the preloading of the pressure signal transmitter 50 under the action of the electrical output signals AS4, AS5 of the fallback device 37, which are output via the switch-over device 38, to set the actual value I.Cp_{N} of the hydraulic pressure in the connection section 42.1, wherein the pump assembly 45 can pump hydraulic fluid out of the container 41 into the connection section 42.1 and wherein the brake valve 46 enables hydraulic fluid to flow out of the connection section 42.1 into the container 41. A fifth sensor in the form of a pressure sensor connected to the connection section 42.1 determines the actual value I.Cp_{N} of the hydraulic pressure in the connection section 42.1 and hence simultaneously the actual value I.P_{N} of the preload pressure, wherein the fallback device 37 is of suitable design, to regulate the preload pressure p_{N} of the pressure signal transmitter 50, to output the output signals AS4, AS5 such that actual value I.Cp_{N}=I.p_{N} corresponds to the load-corrected setpoint value S.Cp_{N}=S.p_{N}.

The further control means 51 are formed by a rapid brake valve. When the rapid brake valve 51 is open (emptied), the pressure signal transmitter 50 is filled—i.e. when the load-dependent preload pressure is too low, the preload pressure of the pressure signal transmitter is increased via the pump assembly 45 (motor-pump unit) and, when the load-dependent preload pressure is too high, it is reduced under the control of the brake valve 46. When the pressure signal transmitter 50 is filled, the rapid brake valve 51 is closed again and remains closed during normal operation.

When the pressure signal transmitter 50 is filled, in addition a hydraulically actuated valve 52, which preferably has an adjustable design, restrains a locking piston 153; 253 against the force of a preload spring 154; 254.

Mechanical actuation 155; 255 can also be used to pull back the locking piston and open a pressure-release valve 56. This enables the manual release of the brake unit 109; 209.

However, the locking piston 153; 253 could also be pulled back by hydraulic actuation.

If the electronics 30 recognize during operation that passive braking via the preload pressure p_{N} of the pressure signal transmitter 50 is necessary, the output of the output signal A3 causes the rapid brake valve 51 to open in order in this way to apply the preload pressure p_{N} of the pressure signal transmitter 50 via the hydraulic pressure Cp_{N} to the brake cylinder 143; 243. The fifth sensor 31.5 in the form of the pressure sensor continuously measures the actual value I.Cp_{N}=I.p_{N} and in particular uses this to hold the preload pressure p_{N} of the pressure signal transmitter 50 within prespecified operational limits and to indicate the availability of this preload pressure p_{N} and hence the availability of the passive braking. If the preload pressure p_{N} of the pressure signal transmitter drops to an excessive degree, it is necessary to refill the pressure signal transmitter 50. In addition, a pressure-relief valve 57 limits the hydraulic pressure Cp_{N} as a passive safety device.

The container 41 is an oil tank, which is sealed from the ambient atmosphere in order to minimize the ingress of moisture. It is only in the case of the occurrence of low pressure in the oil tank that this low pressure is compensated via a valve arrangement 59.

The two brake piston devices 119; 219 comprise locking means designated as a whole with 158; 258, which, in a locked position, are of suitable design to lock the brake piston mechanically for park braking.

The two brake piston devices 119; 219 also comprise means designated as whole with 159; 259 for presetting the air gap L between the first braking means 11 and the second braking means 14 to a prespecified air gap value S.L. These means 159; 259 are of suitable design, in the case of wear on the braking means 11, 14, automatically to reset the air gap L to the prespecified air gap value S.L.

The two brake piston devices 119; 219 also have resetting means designated as a whole with 160; 260, by means of which the brake unit can be transferred into a completely open condition, for example to change the brake linings. In this context, ‘completely open’ means a condition in which the distance between the first braking means 11 and the second braking means 14 is substantially greater than the prespecified air gap value S.L of the air gap L.

With the first embodiment 109 of the brake unit according to the invention shown in FIG. 2, the locking means 158 for mechanically locking the brake piston are spatially separated from the means 159 for presetting the air gap L and the resetting means 160.

The following will initially explain in more detail the mechanical locking of the brake piston 144 and hence the permanent mechanical maintenance of the braking force F_{B} or the contact force Fp_{B}—i.e. a park braking function.

Leakage of hydraulic components of the electrohydraulic setpoint value-force-conversion device 132 to which the hydraulic pressure Cp_{B} is applied can cause the hydraulic pressure Cp_{B} and hence ultimately also the contact force Fp_{B} to fall over time. In order to limit suppression of the contact force Fp_{B} of this kind, in the case of park braking, the motion of the brake piston 144 can optionally be mechanically locked. This is achieved by means of the locking means 158.

To this end, the locking means 158 comprise a non-self-locking threaded spindle 161, which is screwed concentrically into the brake piston 144 and supported on the brake cylinder 143. A ratchet wheel 162 connected to the threaded spindle 161 is prevented from turning in the locked position of the locking piston 153, since in locked position, a locking latch 153.1 of the locking piston 153 engages in a detent groove 162.1 of the ratchet wheel 162. This prevents movement of the brake piston 144 and hence maintains the prevailing actual value I.Fp_{B} for the parking (stopping) of the rail vehicle 1. The mechanical actuation 155 enables the locking piston 153 to be pulled back out of its locked position into a released position and the pressure-release valve 56 to open. This enables the manual release of the brake unit 109.

The following explains the resetting of the air gap L.

In a released position of the brake unit, with which the force of the resetting springs 22 is greater than the contact force Fp_{B} resulting from the braking force F_{B}, a first stop 144.1 of the brake piston 144 lies under the force of the resetting springs 22 on an assigned first stop 163.1 of a locking element 163 embodied as a shut-off slide. On the build-up of the hydraulic pressure Cp_{B}, rotation of the threaded spindle 161 causes the brake piston 144 to move over a setting distance corresponding to the prespecified air gap value S.L from the first stop 163.1 to a second stop 163.2 of the shut-off slide. If there is no wear on the braking means 11, 14, at a prespecified maximum value of the braking force F_{B}, the brake piston 144 strikes with a second stop 144.2 the second stop 163.2. However, if wear on the braking means 11, 12 causes the second stop 163.2 to be reached before the maximum value of the braking force F_{B} takes effect, a further build-up of the hydraulic pressure Cp_{B} causes the brake piston 144 together with the shut-off slide 163, on which the two stops 163.1 and 163.2 are embodied, to travel a further resetting distance. Therefore, the brake piston 144 is reset.

The shut-off slide 163 is provided with fine toothing 163.3 in which, the under the force of a preload spring 164, a locking element 165 embodied as a locking latch engages so that the shut-off slide 163 displaced by the resetting distance is locked again at the end of the resetting.

On the suppression of the hydraulic pressure Cp_{B}, the brake piston 144 does not return over the resetting distance, but only over the setting distance from the second stop 163.2 to the first stop 163.1 and hence again recreates the prespecified air gap value S.L of the air gap L.

The following explains the resetting of the brake piston 144 in more detail. The locking latch 165 forms the locking element, which is held by means of the preload spring 164 in a position engaged with the shut-off slide 163, wherein the shut-off slide 163 limits the opening of the brake to the prespecified air gap value since the first stops 144.1 and 163.1 strike one another. The mechanical actuation 155, which simultaneously serves as an actuation means for the actuation of the locking element 165 is of suitable design to displace the locking element 165 against the force of the preload spring 164 into a position released from the shut-off slide 144.

With the second embodiment 209 of the brake unit according to the invention shown in FIGS. 3 to 12, the locking means 258 for the mechanical locking of the brake piston 244, the means 259 for presetting the air gap L and the resetting means 260 are not spatially separate from one another.

Here, once again, in the case of park braking, the locking means 258 can be used to lock the motion of the brake piston 244 mechanically.

To this end, the locking means 258 once again comprise a non-self-locking threaded spindle 261, which is screwed concentrically into the brake piston 244 and supported on the brake cylinder 243. A ratchet wheel 262, which is connected via toothing 262.2, here face toothing, to toothing 261.2 of the threaded spindle 261 is prevented from rotating by the locking latch 253.1 of the locking piston 253. This prevents motion of the brake piston 244 and hence the braking force F_{B} is maintained. The mechanical actuation 255 enables the locking piston 253 to be pulled back and the pressure-release valve 56 to open. This enables manual release of the brake unit 209. The mechanical actuation 255 comprises a pulling piston 255.1 with a cross pin 255.2, which engages in the locking piston 253, and guidance 255.3 for the pulling piston.

The following explains the resetting of the air gap in more detail.

In released position of the brake unit 209, with which the force of the resetting springs 22 is greater than the contact force Fp_{B} resulting from the braking force F_{B}, the ratchet wheel 262 lies under the force of the resetting springs 22 with a first stop 262.3 on an assigned first stop 270.1, which is supported on the brake cylinder. On the build-up of the hydraulic pressure Cp_{B}, the brake piston 244 is moved by rotation of the threaded spindle 261 over a setting distance, until the ratchet wheel strikes with a second stop 262.4 an assigned second stop 270.2, which is also supported on the brake cylinder.

If there is no wear on the braking means 11, 14, on the closing of the brake unit, the ratchet wheel 262 strikes the second stop 270.2 with a prespecified maximum value of the braking force F_{B}. However, if, due to wear on the braking means 11, 12, the second stop 270.2 is reached before the maximum value of the braking force F_{B} takes effect, a further build-up of the hydraulic pressure Cp_{B} causes torsion between the ratchet wheel 262 and the threaded spindle 261, which are connected via the fine toothing 262.2 and 261.2. On the suppression of the hydraulic pressure Cp_{B}, the brake piston 244 once again travels the setting distance, without the resetting distance, until the ratchet wheel strikes the first stop 270.1 and hence recreates the prespecified air gap L. The two stops 270.1 and 270.2 are adjustable. Instead of connection via the toothing 262.2 and 261.2, it is also possible to select a frictionally engaged connection between the ratchet wheel and the threaded spindle, for example by means of a cone.

The complete opening of the brake unit 209 is once again achieved by the resetting means 260. These resetting means again include actuation means 275, 276, 277 wherein here the threaded spindle 261 as a locking element is held in an engaged position with the locking element 262 by means of the preload spring 273 and the actuation means 275, 276, 277 are of suitable design to displace the threaded spindle 261 against the force of the preload spring 273 into a position released from the locking element 262.

The actuation means 275, 276, 277 comprise a pulling anchor 275, a pulling anchor screw 276 and a pin 277 that is axially displaceable in the pulling anchor via a guide by rotating the pulling anchor screw 276, wherein the preload spring 273 is supported on the pulling anchor 275 and wherein the threaded spindle 261 forms actuation surfaces 261.1 protruding into the trajectory of the pin 277 embodied such that, on the displacement of the pin 277 against the force of the preload spring 273, the threaded spindle 261 is displaced into the position released from the locking element 262.

The following describes the engagement of park braking with the simultaneous resetting of the air gap L once again in more detail with reference to FIGS. 7 to 12.

FIG. 7 shows a starting condition in which the brake unit 209 is open with a maximum air gap.

The brake piston 244 is exposed to a constant, brake-opening hydraulic force Cp_{B} since an entry chamber 243.2 (see FIG. 5) from the store 41 is permanently exposed to pressure. The brake piston 244 is blocked in the position corresponding to the maximum air gap. The brake piston blocking is achieved according to the preceding description by the threaded spindle 261, which is unable to turn since the ratchet wheel 262 strikes the first stop 270.1. The torque of the threaded spindle 261 is transmitted via the engagement of the mutually assigned toothing 261.2, 262.2 to the ratchet wheel 262. The engagement of the toothing cannot be released since the threaded spindle 261 is axially loaded by the force of the brake piston 244.

A proximity switch 271 is open because an indication groove 262.5 of the ratchet wheel is within its detection range. The locking latch 253.1 is hydraulically retracted.

FIG. 8 shows an interim condition of the brake unit 209 with which the air gap L of the brake linings has been overcome and the brake linings lie on the brake disk without force.

This condition was achieved by increasing the hydraulic pressure Cp_{N} in the pullout chamber 243.1 of the brake cylinder 243. The force of the resetting springs 22 has been overcome and the brake piston 244 has moved into the position shown. The threaded spindle 261 turns correspondingly since, on the one hand, the brake piston 244 is mounted in a rotationally fixed manner and, on the other, the threaded spindle 261 is mounted such that it is only able to execute rotary motions. This axial fixation is achieved in that the threaded spindle is pressed by a preload spring 272 (see FIG. 5) against an axial rolling bearing 273.1, 273.2, which is in turn supported on the housing of the brake cylinder 243. This axial force also prevents the release of the face toothing. The proximity switch 271 is closed since the indication groove 262.5 lies outside its detection range.

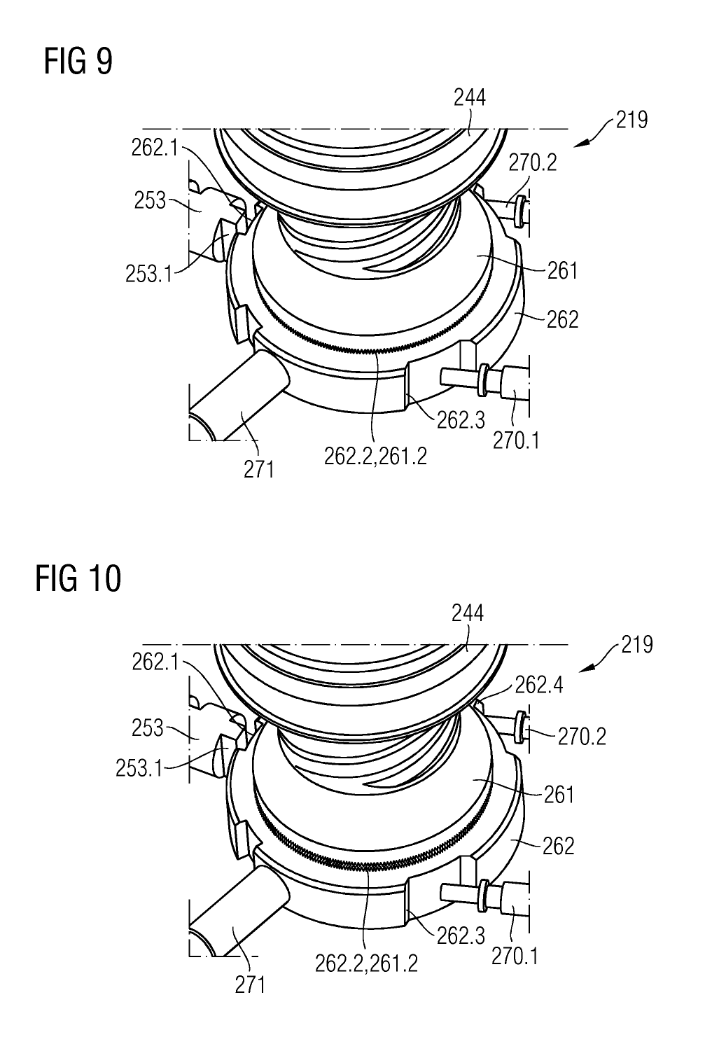

FIG. 9 shows the next interim condition in which the braking force is built up until it is blocked by the ratchet wheel 262. Therefore, the brake piston 244 has moved further due to a further increase in the brake pressure until the ratchet wheel 262 strikes the second stop 270.2. The force on the brake linings had increased linearly in accordance with the spring stiffness of the brake caliper arrangement.

FIG. 10 shows the next interim condition in which the braking force F_{B} is built up until the face toothing 261.2 is disengaged from the face toothing 262.2. The brake cylinder pressure Cp_{B} was increased further with the result that the brake piston 244 has extended further—in accordance with the brake caliper stiffness. However, the ratchet wheel 262 and the threaded spindle 261 were no longer able to turn. As a result, the brake piston 244 pulls on the threaded spindle 261 so that the force of the preload spring 272 is overcome. The face toothing 261.2 starts to separate itself from the face toothing 262.2. It may be identified from a direct comparison of FIG. 9 with FIG. 10 that the threaded spindle 261 has separated from the ratchet wheel 262, even if only slightly (due to the high number of teeth in the face toothing (261.2, 262.2). The separation process is a motion resulting from the combination of an axial motion and rotation of the threaded spindle.

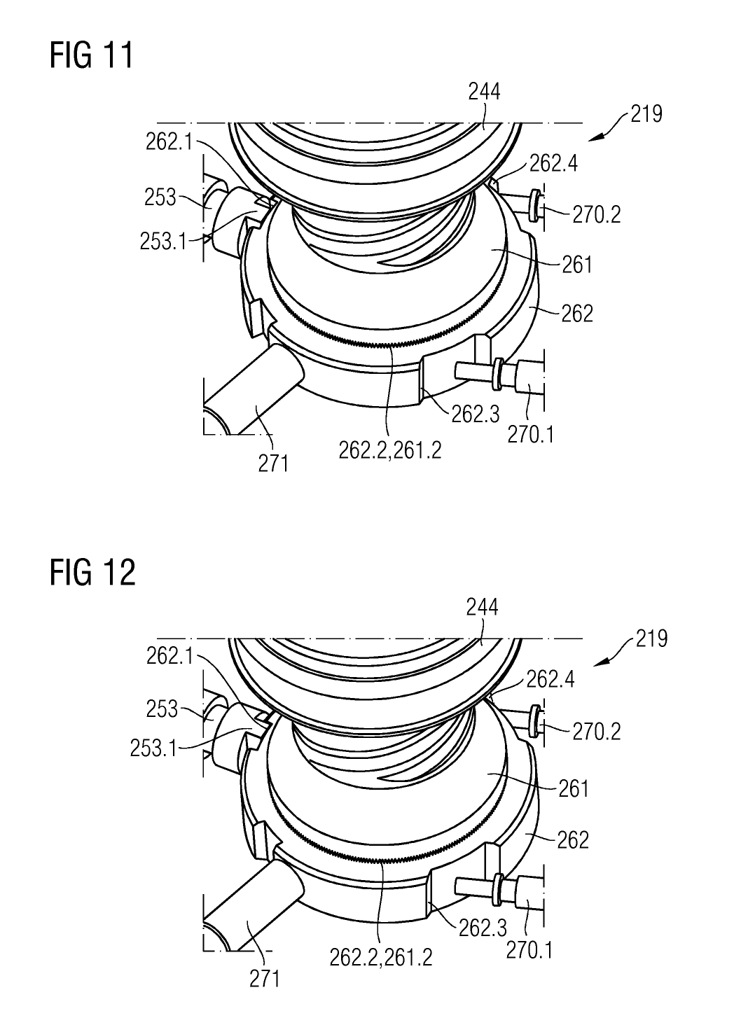

FIG. 11 shows the next interim condition in which the braking force F_{B} is built up until the face toothing 261.2 is further latched against the face toothing 262.2 and in which the locking latch 253.1 of the locking piston 253 has then fallen into the detent groove 262.5 of the ratchet wheel 262. Therefore, the brake cylinder pressure Cp_{B} was increased further. The threaded spindle 261 also experienced superimposition of axial disengagement and rotation until the tooth tips of the face toothing 261.2, 262.2 were opposite each other. In the next moment, the face toothing 261.2 abruptly jumped into the next tooth pitch of the face toothing 262.2 and is once again in engagement with the face toothing 262.2, i.e. is latched further. Complete engagement in the next tooth pitch was geometrically possible since the ratchet wheel 262 was moved slightly backward by the engagement process (disengaged from the second stop 270.2). This process of the relatching of the face toothing only takes place when the brake piston 244 is able to extend far enough due to brake-lining and brake-disk wear. If this wear condition has not yet been reached, when the brake unit is released, the face toothing 261.2 returns to the original engagement with the face toothing 262.2. The hydraulic retention of the locking piston 253 was then cancelled and due to spring force, it fell into the detent groove 262.1 of the ratchet wheel 262.

FIG. 12 shows the target condition with park braking in which the locking means 158—that is the mechanical park braking locking—is active. Therefore, the brake cylinder pressure Cp_{B} was suppressed, the brake piston 244 moved back until its backward movement was blocked by the locking pin 253.

The brake unit according to the invention in particular offers the following advantages:

The brake unit does not have any external hydraulic interfaces and hence no hydraulic line, pipe or hose links to the vehicle. The only external interfaces from the brake unit to the vehicle or to the brake controller are interfaces used to supply power or transmit signals. Hence, the integrated hydraulic circuit is a compact design that, via the provision of the regulated braking force F_{B}, enables actively regulated operational braking, emergency braking or rapid braking, a hydraulically and/or mechanically actuated and lockable park braking function and, via the provision of the passive emergency braking force F_{N}, passive emergency braking.

The setting and wear adjustment of the air gap L is in particular achieved in a structurally simple way and the moved parts are here in the hydraulic medium thus reducing the risk of jamming and wear on the moved parts.

A distance sensor 171 and/or the switch 271 reliably detect a released brake unit. The sensor device 31 is also able to detect a seized up brake.

The brake unit according to the invention 9; 109; 209 enables the achievement of a deceleration-regulated braking system 8, which offers additional braking-distance safety.

The parameterization of braking characteristics of the brake unit according to the invention enables the brake unit according to the invention to be adapted in a simple way for specific projects so that a maximum degree of standardization can be achieved with this brake unit.

1-12. (canceled)

13. A brake unit for a vehicle or a rail vehicle, the brake unit comprising:
an electrohydraulic setpoint value-force-conversion device including control devices, a container for providing hydraulic fluid, a brake cylinder with brake pistons, and a hydraulic line system connecting said brake cylinder to said container; and
a setpoint-value-regulating device providing electrical output signals;
said control devices being configured to set an actual value of a hydraulic pressure in said brake cylinder acting upon said brake piston under action of said electrical output signals;
one of said control devices being a pump assembly for pumping hydraulic fluid out of said container into said brake cylinder and another of said control devices being suitably configured to allow hydraulic fluid to flow out of said brake cylinder into said container.

14. The brake unit according to claim 13, which further comprises first and second braking devices, said first braking device bring suitably constructed to convert an actual value of a contact force resulting from an action of said brake piston into an actual value of a deceleration parameter by friction locking with said second braking device.

15. The brake unit according to claim 14, which further comprises a connecting part for mounting the brake unit, and a modular unit, said setpoint value-force-conversion device and said first braking device being connected to said modular unit by said connecting part.

16. The brake unit according to claim 15, wherein said connecting part mounts the brake unit on a running gear of a rail vehicle.

17. The brake unit according to claim 13, which further comprises:
a sensor device determining said actual value of the hydraulic pressure or said actual value of said contact force as at least one of an actual value of a contact parameter or an actual value of a deceleration parameter;
said setpoint-value-regulating device being suitably constructed for regulating said deceleration parameter to output said output signals to cause said actual value of said determined deceleration parameter to at least correspond to a setpoint value of said deceleration parameter or, for regulating said contact parameter to input said output signals to cause said actual value of said determined contact parameter to correspond to a setpoint value of said contact parameter.

18. The brake unit according to claim 14, which further comprises a device for presetting an air gap between said first braking device and said second braking device to a prespecified air gap value.

19. The brake unit according to claim 18, wherein said device for presetting said air gap is suitably constructed to automatically reset said air gap to said prespecified air gap value in the event of wear of at least one of said braking devices.

20. The brake unit according to claim 18, wherein said device for presetting said air gap includes a non-self-locking threaded spindle being concentrically screwed into said brake piston, a ratchet wheel connected to said threaded spindle by face toothing or friction locking supported by an axial rolling bearing on said brake cylinder and two stops restricting an angle of rotation of said ratchet wheel to a prespecified value of said angle of rotation.

21. The brake unit according to claim 20, wherein said angle of rotation has a value being adjustable by moving said stops.

22. The brake unit according to claim 20, which further comprises a locking device being suitably constructed to lock said brake piston mechanically for park braking.

23. The brake unit according to claim 22, wherein said locking device includes a locking latch being suitably constructed to engage in a detent groove of said ratchet wheel.

24. The brake unit according to claim 23, wherein said locking latch is actuable at least one of hydraulically or mechanically.

25. A vehicle or a rail vehicle, comprising:
a running gear including a wheel set having a braking device; and
a brake unit according to claim 13 being mounted on said running gear for friction locking with said braking device.
